(19) United States
(12) Patent Application Publication
(10) Pub. No.: US 2016/0352192 A1
(43) Pub. Date: Dec. 1, 2016

(54) SERVOMECHANISM WITH CONTROLLABLE FORCE OF ACTION

(71) Applicant: MY RESEARCH, UAB, Vilnius (LT)

(72) Inventor: Aleksej ZAICEVSKIJ, Traku r. (LT)

(21) Appl. No.: 15/116,656

(22) PCT Filed: Dec. 23, 2014
(86) PCT No.: PCT/LT2014/000016

§ 371 Date: Aug. 4, 2016

(30) Foreign Application Priority Data
Feb. 5, 2014 (LT) 2014 013

(51) Int. Cl. H02K 11/33; H02K 11/00

(52) U.S. Cl. CPC H02K 11/33; H02K 11/0094

(57) ABSTRACT

A servomechanism with internal feedback to control torque allows expansion of the range of controlled force values. This is realized in several ways: by combining different measuring methods of acting forces, combining resilient members with different deformation coefficients in the coupling, using different types of motors in combination. Optionally a force sensor with non-linear dependency is used. Additionally it is possible to change the mode of operation by changing the feedback signal coefficient of the acting force. Areas of application: remote-controlled light machines, robots, manipulators, radio-controlled models, steering parts for cameras, interfaces to interact with living organisms. When used to rotate a camera, high rotation speed and high precision of position are maintained.

### FIELD OF THE INVENTION

The invention is related to devices with internal feedback in particular it is related to servomechanisms with internal feedback to control torque.

### BACKGROUND OF THE INVENTION

U.S. application Ser. No. 13/623,174 discloses rotary actuator having a final output member rotatable about an axis of rotation; a motor unit designed to drive the final output member for rotation about the axis of rotation; and an elastic unit arranged between the motor unit and the final output member and having an input member torsionally coupled to the motor unit and an output member rigidly connected for rotation with the final output member are provided. Drawback of this invention is that deformation from the load side is linear and force measuring precision is not increased with respect to stretch of resilient member.

The closes prior art is international patent application PCT/LT2013/000018, published as WO2014/185759, disclosing a servomechanism with proportionally controlled force acting on a working body. Shortcoming of the disclosed servomechanism is the lack of control accuracy under small loads. For instance, stabilization of devices like cameras requires precise control of weak acting forces. Intentional rotation of such devices requires greater force and control of accuracy of such force can be quite rough. Another example is a robotic manipulator suitable for grasping fragile low mass objects, which requires more accurate control of force of action compared to handling heaver objects.

### SUMMARY OF THE INVENTION

The purpose of the invention is to expand range of controlled forces of a servomechanism. For the purpose of the description of the invention term “servomechanism” should be interpreted as a device comprising electric motor, a mechanical reducer, a resilient element, a force sensor and electronic controller of the electric motor.

One aspect of the invention is the use of resilient elements with nonlinear deformation properties in a coupling. Second aspect of the invention is the use of different force sensors in one servo drive for different ranges. Third aspect of the invention is the use of combination of different types of motors.

### BRIEF DESCRIPTION OF THE DRAWINGS

FIG. 1 depicts an example of the use of resilient coupling comprising a rotation axis (1), spring abutments (2, 3) in a driving coupling, spring abutments (4, 5) in a driven coupling, compression springs (6-9).

FIG. 2 depicts installation of two resilient couplings in series, comprising a rotation axis (10), a driving coupling (11), intermediate member (12), a driven coupling (13) and a torque sensor, axis (14) of a working body, springs (15, 16).

FIG. 3 depicts a torque sensor, comprising a rotation axis (17), aluminum frame (18), a position (19, 20) for coupling with driving coupling, strain gauges (21-24), printed circuit board (25) of electric bridging connection of strain gauges.

FIG. 4 depicts an example of resilient coupling, comprising axis of rotation (26), a driving member (27) and a driven member (28), tension springs (29, 30).

FIG. 5 depicts an example of force sensor operating together with resilient coupling as shown in FIG. 4. Said force sensor comprises axis of rotation (31), a driving member (32), a driven member (33), a magnetic field sensor (34), a magnet (35), a trimmer (36) and indicator (37).

In FIG. 6 a plot of change of signal of the force sensor (as represented in FIG. 5) under deformation of the resilient coupling (as represented in FIG. 4) is shown wherein the non-linear plot line (38) represents a non-linear dependency of a feedback signal on magnitude of deformation.

FIG. 7 depicts an example of a combined coupling, comprising axis of rotation (39), a driving member (40), a driven member (41), magnets of a driven coupling (42-45), magnets of a driving coupling (46-49), dampers (50-53), coils of electromagnets (54, 55).

### DETAILED DESCRIPTION OF THE INVENTION

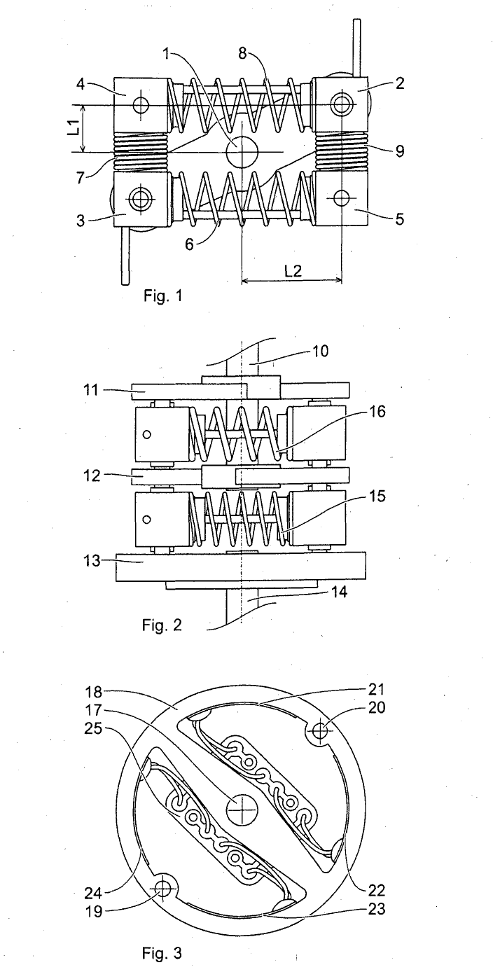

The resilient coupling of FIG. 1 comprises compression springs (6-9) which under compression moves away from axis of rotation and moment arm increases. For comparison moment arms are denoted by L1 and L2. This coupling ensures exponential increase in force when driven coupling is displaced relatively to the driving coupling.

FIG. 2 shows an example of two couplings installed in series. Each of said couplings has analogous structure as the one depicted in FIG. 1. Springs (15, 16) with different deformation coefficients are installed in both couplings. The intermediate member (12) is mounted on a separate bearing. The strain gauge (13) of torque measures torque. Data of the strain gauge (13) are used as feedback signal data of torque. When load is increased, weak springs (15) are fully compressed first and subsequently stiffer springs (16) are also compressed. Electric motor of the servomechanism transmits driving force through a mechanical reducer. For the weak springs (15) and stiffer springs (16) to be separately and fully compressed the electric motor has to make even number of turns. But when the weak springs (15) are compressed, the driven member receives a smaller amount of torque compared to when stiffer springs (16) are compressed and thus more precise torque control can be achieved under smaller loads. The servomechanism can comprise any number of resilient members in series and with different deformation coefficients.

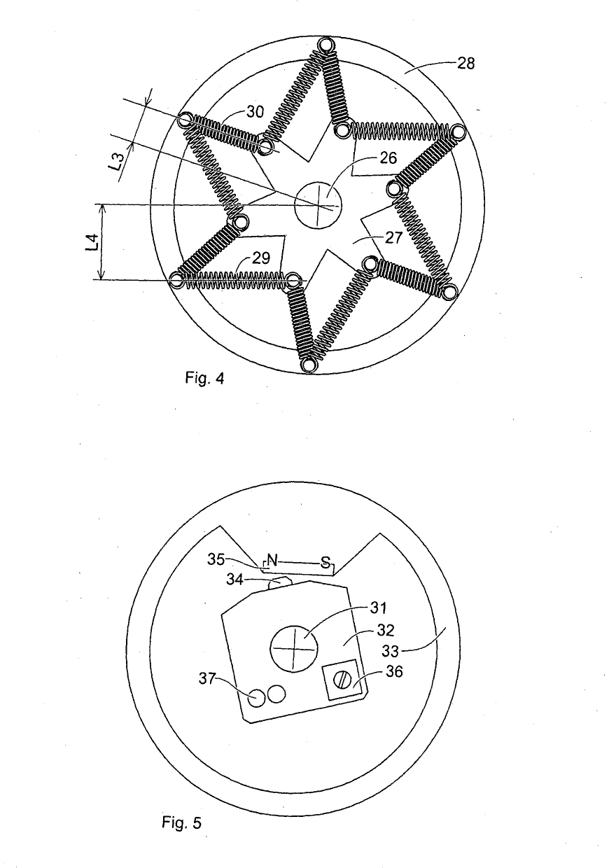

FIG. 3 shows the strain gauge (13) of torque, installed in the mechanism according to FIG. 2. The sensor is fixed on axis of a working body (14, 17). The force is transmitted to the aluminum frame (18) via a mounting (19, 20). Deformation of the frame (18) is registered by the strain gauges (21-24). A printed circuit board (25) interconnects sensors (21-24) of electric bridging connection for measuring electric signal.

FIG. 4 shows an example of tension-springs based resilient coupling. Such coupling is easier to manufacture compared to that shown in FIG. 1, but its size is larger.

A driving member (27) is fixed on a axis (26). The driven member (28) is connected to the driving member (27) through twelve springs (29, 30). In this example, the driving member (27) is rotated counterclockwise. Torque is transmitted through the tension springs (29). The higher the load on the driven member (28), the greater increase is in the moment arm L4. Moment arm L3 acting in the opposite direction to the spring (30) is reduced.

FIG. 5 shows a force sensor used in conjunction with the coupling shown in FIG. 4. A bipolar linear magnetic field sensor (34) and electrical signal amplifier (32) are fixed in the driving member (27, 32) of the coupling. A magnet (35) is fixed on the driven member (28, 33). A trimmer (36) allows accurate detection of the neutral position signal. Two-color LED indicator (37) lights up in one of two colors if the sensor (34) detects a deviation from the neutral position. If required, LED indicator (37) allows more precise balancing of the load on the servomechanism.

Deformation of the resilient coupling (FIG. 4) causes displacement of the Hall sensor (34), relatively to the magnet (35), when the sensor gets closer to one of the poles of the magnet (35). At the same time a gap between the magnet (35) and the Hall sensor (34) also increases. Signal from such force sensor is not linear. FIG. 6 is a plot of the dependency of the magnetic field sensor (38) signal from angular displacement between the driving coupling (27) and the driven coupling (28). The sensor has higher dependency ratio for small deviations, providing more precise control of power of small values.

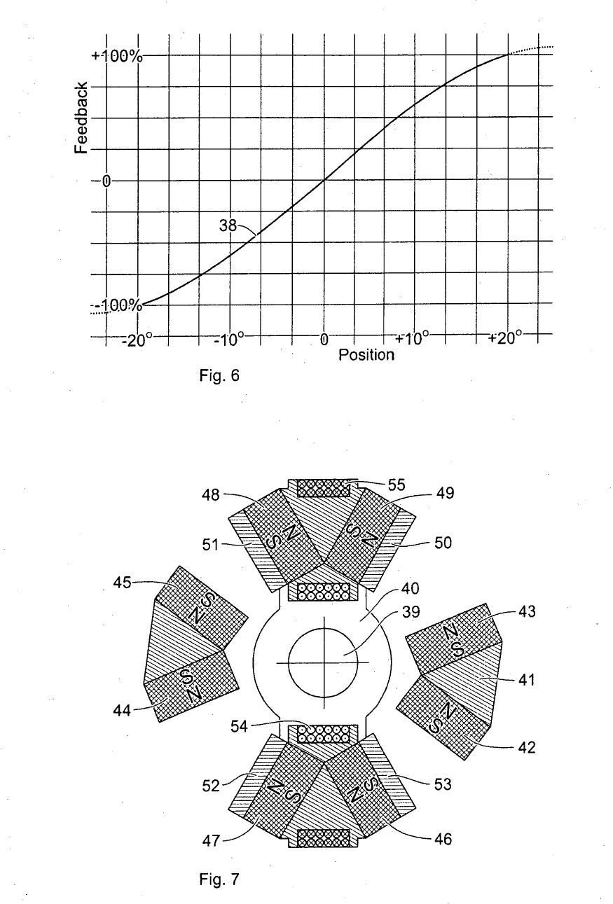

FIG. 7 shows an example of coupling having repulsive magnets (42-49) instead of springs. Magnets provide exponential increase in the repulsive force, when they are being brought together. Soft dampers (50-53) allow the driven coupling to touch the driving coupling. When a gap is present between the magnets (42-45) of the driven coupling and the magnets (46-49) of the driving coupling the acting force is determined according to the displacement of the driven coupling (41), relative to the driving coupling (40). A magnetic rotation encoder (not shown) is used to measure the displacement and is mounted between the driving member (40) and driven member (41) of the magnetic coupling. After the magnets (42-49) contact each other via the soft damper (50-53) the force of action is determined according to current consumption of a motor. This allows increasing maximum torque exceeding the contactless limits of the magnetic coupling. The mechanism is protected against mechanical overloads by regulating increase rate of the force of action by means of a computer program. Coils of electromagnets (54, 55) interact with magnets (42-45) of the driven coupling and effect a weak but fast resulting action. Furthermore additional linear motor comprises combination of electromagnets (54, 55) and permanent magnets (42-45). If the servomechanism is used to stabilize cameras, forces of inertia make the driven coupling to deflect with respect to the driving coupling. In this case the driving coupling is forced by the motor to catch up with the driven coupling. The motor with a reducer ensures delayed reaction and the linear motor is used to compensate this delay. The force generated by the electric magnet in this example cannot be measured and is considered to be proportional to the magnitude of a given electric signal. A digital controller of the servomechanism contains a table of values for the control of the linearization of the forces by combining different methods for measuring a force.

The amplification coefficient of the feedback signal affects performance of the servomechanism. Increasing performance speed will results in increased consumption of energy which may lead to overheating of the servomechanism. A thermal sensor is connected to the motor controller to control temperature. The amplification coefficient of the feedback signal is reduced with increase in temperature to avoid overheating. In another instance additional control signal of the servomechanism is used to alter the coefficient of the feedback signal. Changing the feedback coefficient allows changing mode of operation of the servomechanism in a wider range than by using only one control signal of the force of action.

The disclosed invention allows increasing accuracy and expanding application field of mechanical devices with controlled force of action. Main application fields are remote-controlled light machines, robots, radio-controlled models, steering parts for cameras, interfaces to interact with living organisms.

1-11. (canceled)

12. Servomechanism with controlled force acting on a working body, having electric motor, a mechanical reducer, a force sensor and electronic electric motor controller, wherein mechanical action is transferred to the working body through a resilient element, having nonlinear deformation characteristics wherein the resilient element is a resilient coupling comprising a driving part (27) mounted on a driving shaft (26) and a driven part (28) being interconnected by the tension springs (29, 30) in one plane of angular rotation wherein said tension springs (29, 30) are fixed closer to the center of angle of rotation at their firs end and further from the center of rotation at their second end wherein the force is measured according to relative motion of driving (27) and driven (28) parts.

13. Servomechanism according to claim 12 wherein the tension springs (29, 30) are connecting the driving part (27) and the driven part (28) in such a way that the tension springs are forming a continuous connection between said springs (29, 30).

14. Servomechanism according to claim 12, further comprising a force sensor, mounted on the driving shaft (26) comprising a bipolar linear magnetic field sensor (34) and an electric signal amplifier (32) being fixed on the driving part (27) of the coupling, a magnet (35), being fixed on the driven member (28, 33), a trimer (36) and a LED indicator (37).

15. Servomechanism according to claim 13, further comprising a force sensor, mounted on the driving shaft (26) comprising a bipolar linear magnetic field sensor (34) and an electric signal amplifier (32) being fixed on the driving part (27) of the coupling, a magnet (35), being fixed on the driven member (28, 33), a trimer (36) and a LED indicator (37).
